(19) United States
(12) Patent Application Publication
(10) Pub. No.: US 2025/0319876 A1
(43) Pub. Date: Oct. 16, 2025

(54) CONTROL APPARATUS AND CONTROL METHOD

(71) Applicant: Robert Bosch GmbH, Stuttgart (DE)

(72) Inventors: Masahiro Ohno, Kanagawa (JP); Katsuya Sano, Hokkaido (JP); Yumeta Seki, Kanagawa (JP)

(21) Appl. No.: 19/176,959

(22) Filed: Apr. 11, 2025

(30) Foreign Application Priority Data
Apr. 16, 2024 (JP) 2024-066220

(51) Int. Cl. B60W 30/18; B60W 10/04; B60W 10/18

(52) U.S. Cl. CPC B60W 30/18172; B60W 10/04; B60W 10/18; B60W 2520/26; B60W 2710/18; B60W 2720/26

(57) ABSTRACT

An object of the invention is to optimize the behavior of a vehicle. A control apparatus is a control apparatus that controls a behavior of a vehicle, and includes a control unit that executes, when slip of a wheel occurs due to a driving force, a first control of eliminating the slip and a second control of generating a larger braking force, as compared to the first control, at the wheel at which the slip is occurring. The control unit automatically executes the second control in response to the behavior of the vehicle.

### BACKGROUND

The present invention relates to a control apparatus and a control method.

For the purpose of stabilizing the behavior of a vehicle, technologies for eliminating slip of a wheel due to a driving force have been proposed. Examples of such techniques include a control of reducing a driving force of a vehicle when slip of a wheel occurs due to the driving force, as disclosed in JP 2007-049825 A.

### SUMMARY

There are various situations in which slip of a wheel occurs due to a driving force. Thus, it is desirable to respond to an ongoing situation in order to optimize the behavior of a vehicle.

The invention has been made in view of the above problem, and an object thereof is to provide a control apparatus and a control method capable of optimizing the behavior of a vehicle.

In order to solve the above problem, a control apparatus is a control apparatus that controls the behavior of a vehicle, and includes a control unit that executes, when slip of a wheel occurs due to a driving force, a first control of eliminating the slip and a second control of generating a larger braking force, as compared to the first control, at the wheel at which the slip is occurring. The control unit automatically executes the second control in response to the behavior of the vehicle.

In order to solve the above problem, a control method is a control method for controlling the behavior of a vehicle, and causes a control unit of a control apparatus to execute, when slip of a wheel occurs due to a driving force, a first control of eliminating the slip and a second control of generating a larger braking force, as compared to the first control, at the wheel at which the slip is occurring. The control unit automatically executes the second control in response to the behavior of the vehicle.

According to the invention, the behavior of the vehicle can be optimized.

### BRIEF DESCRIPTION OF THE DRAWINGS

FIG. 1 is a schematic diagram illustrating a schematic configuration of a vehicle according to an embodiment of the invention.

FIG. 2 is a schematic diagram illustrating a schematic configuration of a brake system according to the embodiment of the invention.

FIG. 3 is a block diagram illustrating an example of a functional configuration of a control apparatus according to the embodiment of the invention.

FIG. 4 is a diagram illustrating a state in which the vehicle according to the embodiment of the invention travels on a low μ road.

FIG. 5 is a diagram illustrating a state in which the vehicle according to the embodiment of the invention travels on an off-road.

FIG. 6 is a diagram illustrating an example of the transitions of a driving force and a braking force of the vehicle in each traction control executed by the control apparatus according to the embodiment of the invention.

FIG. 7 is a diagram for explaining the transitions of processing modes in the traction control executed by the control apparatus according to the embodiment of the invention.

FIG. 8 is a flowchart illustrating an example of a processing flow during a permission mode executed by the control apparatus according to the embodiment of the invention.

FIG. 9 is a diagram illustrating a state in which only the left wheels of the vehicle according to the embodiment of the invention are located on the low μ road.

FIG. 10 is a diagram illustrating an example of the transition of acceleration of a wheel of the vehicle according to the embodiment of the invention.

FIG. 11 is a diagram illustrating an example of the transitions of a driving force and a speed of the vehicle according to the embodiment of the invention.

### DETAILED DESCRIPTION

A preferred embodiment of the invention will be described in detail below with reference to the accompanying drawings. Dimensions, materials, other specific numerical values, and the like described in the embodiment are only given as examples for facilitating understanding of the invention, and do not limit the invention unless otherwise specified. In the present specification and the drawings, components having substantially the same functions and configurations are denoted by the same reference signs to omit redundant descriptions, and components not directly related to the invention are not illustrated.

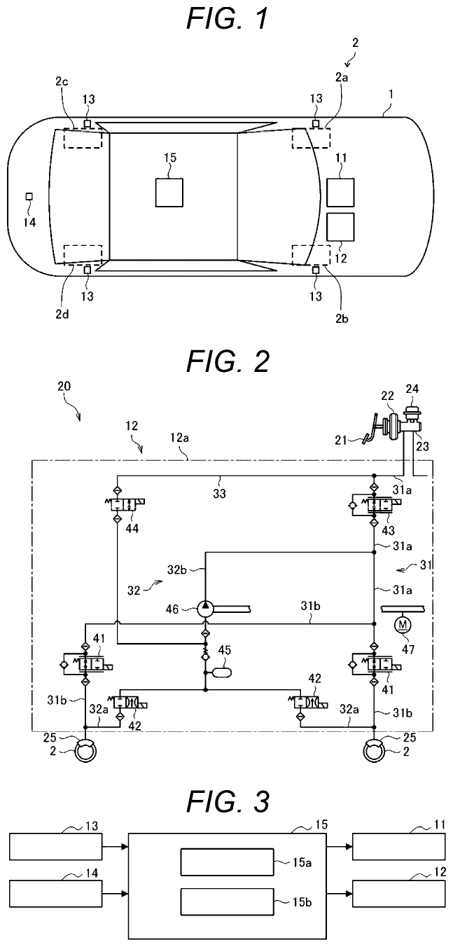

A configuration of a vehicle 1 according to an embodiment of the invention will be described with reference to FIG. 1 to FIG. 4.

FIG. 1 is a schematic diagram illustrating a schematic configuration of the vehicle 1. As illustrated in FIG. 1, the vehicle 1 includes a plurality of wheels 2, a drive source 11, a hydraulic pressure control unit 12, a plurality of wheel speed sensors 13, an inertia measurement unit (IMU) 14, and a control apparatus 15. The vehicle 1 includes four wheels 2, that is, a left front wheel 2a, a right front wheel 2b, a left rear wheel 2c, and a right rear wheel 2d. However, the number of the wheels 2 may be other than 4.

The drive source 11 outputs a driving force to be transmitted to the wheels 2. Examples of the drive source 11 include an engine. As the drive source 11, an electric motor may be provided in the vehicle 1 instead of or in addition to the engine.

The hydraulic pressure control unit 12 controls the braking force of the vehicle 1. The hydraulic pressure control unit 12 controls a braking force applied to the wheels 2 by controlling a wheel cylinder pressure which is a hydraulic pressure of a brake fluid of a wheel cylinder. The details of the hydraulic pressure control unit 12 will be described below.

The wheel speed sensor 13 is provided at each of the wheels 2 to detect a wheel speed of each of the wheels 2.

The inertia measurement unit 14 includes a three-axis gyro sensor and a three-direction acceleration sensor and detects an angular velocity and an acceleration of the vehicle 1. The detection result of the inertia measurement unit 14 is used, for example, to estimate the attitude of the vehicle 1. The inertia measurement unit 14 may include only a part of the three-axis gyro sensor and the three-direction acceleration sensor.

The control apparatus 15 controls the movement of the vehicle 1. The control apparatus 15 includes a central processing unit (CPU) which is an arithmetic processing unit, a read-only memory (ROM) which is a memory element storing programs, arithmetic parameters, and the like used by the CPU, and a random access memory (RAM) which is a memory element temporarily storing parameters that change appropriately in the execution of the CPU and the like. The details of the control apparatus 15 will be described below.

FIG. 2 is a schematic diagram illustrating a schematic configuration of a brake system 20 of the vehicle 1. The brake system 20 is a system that is mounted to the vehicle 1 so as to control the braking force generated in the vehicle 1. As illustrated in FIG. 2, the brake system 20 includes the hydraulic pressure control unit 12, a brake pedal 21, a booster 22, a master cylinder 23, a reservoir 24, and wheel cylinders 25.

The brake system 20 controls the braking force generated at the respective wheels 2 by controlling the hydraulic pressure of the wheel cylinders 25 (i.e., a wheel cylinder pressure) respectively provided to the wheels 2. In FIG. 2, for ease of understanding, only a part related to two wheels 2 out of four wheels 2 (e.g., the left front wheel 2a and the right rear wheel 2d) is illustrated, and a part related to the other two wheels 2 (e.g., the right front wheel 2b and the left rear wheel 2c) is omitted.

The brake pedal 21 is used in a braking operation by a driver. In the brake operation, the brake pedal 21 is pressed by the driver. The booster 22 is connected to the brake pedal 21 and amplifies the pedaling force of the brake pedal 21 in conjunction with the brake pedal 21. Specifically, the booster 22 includes a piston reciprocating in conjunction with the brake pedal 21 and is connected to the master cylinder 23. The piston moves in response to a braking operation, thereby increasing a master cylinder pressure which is the hydraulic pressure of the master cylinder 23. In this way, the booster 22 can generate a master cylinder pressure in accordance with the operation amount of the braking operation. The reservoir 24 is attached to the master cylinder 23 and stores a brake fluid.

The hydraulic pressure control unit 12 includes a base 12a formed with flow paths of the brake fluid. The master cylinder 23 and each of the wheel cylinders 25 are connected to the base 12a of the hydraulic pressure control unit 12. When the wheel cylinder pressure, which is the hydraulic pressure of the wheel cylinders 25, increases, brake pads (not illustrated) move so as to be pressed against brake discs (not illustrated), respectively, whereby a braking force corresponding to the wheel cylinder pressure is applied to the wheels 2.

The base 12a of the hydraulic pressure control unit 12 is formed with a main flow path 31, an auxiliary flow path 32, and a supply flow path 33 as the flow paths of the brake fluid. The main flow path 31 delivers the brake fluid of the master cylinder 23 to the wheel cylinders 25. The auxiliary flow path 32 releases the brake fluid of the wheel cylinders 25. The supply flow path 33 supplies the brake fluid of the master cylinder 23 to the auxiliary flow path 32.

The base 12a of the hydraulic pressure control unit 12 is provided with, as components for controlling the braking force generated at the respective wheels 2, inlet valves (EV) 41, outlet valves (AV) 42, a first valve (USV) 43, a second valve (HSV) 44, an accumulator 45, a pump 46, and a motor 47.

The main flow path 31 communicates with the master cylinder 23 and the wheel cylinders 25. The main flow path 31 includes one first main flow path 31a and two second main flow paths 31b. The first main flow path 31a is connected to the master cylinder 23. The two second main flow paths 31b are branched off from the first main flow path 31a and connected to the respective wheel cylinders 25. The first main flow path 31a is provided with the first valve 43. Each of the second main flow paths 31b is provided with the inlet valve 41.

The auxiliary flow path 32 communicates with the wheel cylinder 25 side of the inlet valves 41 in the main flow path 31 and communicates with the master cylinder 23 side of the inlet valves 41 and the wheel cylinder 25 side of the first valve 43 in the main flow path 31. The auxiliary flow path 32 includes two first auxiliary flow paths 32a and one second auxiliary flow path 32b. The first auxiliary flow paths 32a are connected to the wheel cylinder 25 side of the inlet valves 41 in the main flow path 31, respectively. The second auxiliary flow path 32b connects the junction of the two first auxiliary flow paths 32a and the master cylinder 23 side of the inlet valves 41 and the wheel cylinder 25 side of the first valve 43 in the main flow path 31. Each of the first auxiliary flow path 32a is provided with the outlet valve 42. The second auxiliary flow path 32b is provided with the accumulator 45 and the pump 46 in this order from the first auxiliary flow path 32a side.

The pump 46 is driven by the motor 47 to suck the brake fluid from the first auxiliary flow path 32a side and discharge the brake fluid to the main flow path 31 side. The pump 46 is a reciprocating plunger pump. Specifically, a plunger of the pump 46 reciprocates by being intermittently pressed by an eccentric cam provided to an output shaft of the motor 47. Accordingly, the pump 46 pumps the brake fluid.

The supply flow path 33 communicates with the master cylinder 23 side of the first valve 43 in the main flow path 31 and the suction side of the pump 46 in the auxiliary flow path 32. The supply flow path 33 is provided with the second valve 44.

The inlet valves 41 are, for example, solenoid valves that are opened in a non-energized state and closed in an energized state. The outlet valves 42 are, for example, solenoid valves that are closed in a non-energized state and opened in an energized state. The first valve 43 is, for example, a solenoid valve that is opened in a non-energized state and closed in an energized state. The second valve 44 is, for example, a solenoid valve that is closed in a non-energized state and opened in an energized state. By controlling the operations of these valves and the motor 47, the braking force generated at each of the wheels 2 is controlled.

For example, in a normal state in which an anti-lock brake control, which will be described below, or the like is not executed, the inlet valves 41 are opened, the outlet valves 42 are closed, the first valve 43 is opened, and the second valve 44 is closed. Accordingly, the brake fluid flows from the master cylinder 23 to the wheel cylinders 25 through the main flow path 31 only, without through the auxiliary flow path 32 and the supply flow path 33. In this state, when the brake pedal 21 is pressed, the master cylinder pressure is increased and the wheel cylinder pressure is increased, and thus a braking force is applied to the wheels 2.

For example, when the anti-lock brake control for preventing the wheels 2 from being locked is executed, first, the inlet valves 41 are closed, the outlet valves 42 are opened, the first valve 43 is opened, and the second valve 44 is closed. Accordingly, the flow of the brake fluid between the main flow path 31 and the wheel cylinders 25 is stopped, enabling the brake fluid to flow from the wheel cylinders 25 to the auxiliary flow path 32. Thus, the brake fluid flows from the wheel cylinders 25 into the accumulator 45, the wheel cylinder pressure is reduced, and the braking force applied to the wheels 2 is reduced. The brake fluid having flowed into the accumulator 45 is returned to the main flow path 31 via the auxiliary flow path 32 by the pump 46 being driven.

Then, when both the inlet valves 41 and the outlet valves 42 are closed in the state described above, the flow of the brake fluid between the main flow path 31 and the wheel cylinders 25 and between the auxiliary flow path 32 and the wheel cylinders 25 is stopped, and the wheel cylinder pressure is maintained and the braking force applied to the wheels 2 is maintained. Subsequently, the inlet valves 41 are opened and the outlet valves 42 are closed, so that the flow of the brake fluid between the main flow path 31 and the wheel cylinders 25 is resumed, and thus the wheel cylinder pressure is increased and the braking force applied to the wheels 2 is increased.

Here, the hydraulic pressure control unit 12 can also automatically increase the wheel cylinder pressure without a braking operation. For example, when the wheel cylinder pressure is automatically increased without a braking operation, the inlet valves 41 are opened, the outlet valves 42 are closed, the first valve 43 is closed, and the second valve 44 is opened. Accordingly, the brake fluid flows from the master cylinder 23 to the wheel cylinders 25 through the supply flow path 33 and the auxiliary flow path 32. In this state, the pump 46 is driven, so that the wheel cylinder pressure is increased and a braking force for braking the wheels 2 is generated.

It should be noted that, in automatically increasing the wheel cylinder pressure, when some of the inlet valves 41 are opened and the remaining inlet valves 41 are closed, the braking force can be applied only to the wheels 2 corresponding to the some of the inlet valves 41.

FIG. 3 is a block diagram illustrating an example of a functional configuration of the control apparatus 15. For example, one control apparatus 15 may be provided, or the control apparatus 15 may be divided into a plurality of apparatuses. When the control apparatus 15 is divided into a plurality of apparatuses, various functions to be described below are shared by the plurality of apparatuses, and thus a part of the functions of a control unit 15b to be described below and another part of the functions may be implemented by different apparatuses.

As illustrated in FIG. 3, the control apparatus 15 includes, for example, an acquisition unit 15a and the control unit 15b.

The acquisition unit 15a acquires information from each apparatus in the vehicle 1. For example, the acquisition unit 15a acquires information from the wheel speed sensors 13 and the inertia measurement unit 14. It should be noted that in the present specification, acquisition of information includes extraction or generation of information (e.g., arithmetic operation), and the like.

The control unit 15b executes various controls by controlling the operation of each apparatus in the vehicle 1. For example, the control unit 15b controls the operation of the drive source 11 and the hydraulic pressure control unit 12.

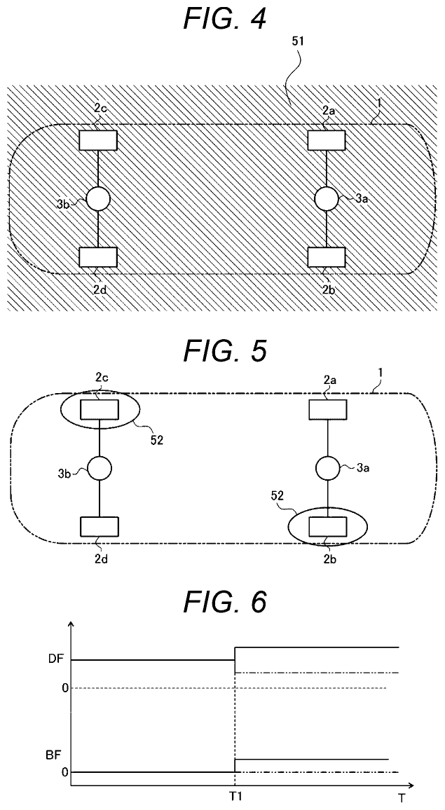

The control unit 15b can execute a traction control which is a control for stabilizing the behavior of the vehicle 1 by eliminating slip (i.e., idling) of the wheels 2 caused by a driving force while the vehicle 1 is traveling. As will be described below, the control unit 15b can execute an off-road traction control which is a traction control for off-road travel, and a normal traction control different from the off-road traction control in a switchable manner. The normal traction control is an example of the first control according to the invention and the off-road traction control is an example of the second control according to the invention. Hereinafter, the normal traction control will be described with reference to FIG. 4, prior to the description of the off-road traction control.

FIG. 4 is a diagram illustrating a state in which the vehicle 1 travels on a low μ road 51. In FIG. 4, the low μ road 51 is indicated by hatching. The low μ road 51 refers to a road surface with a low friction coefficient, such as a frozen road surface. As illustrated in FIG. 4, the vehicle 1 includes a front differential apparatus 3a and a rear differential apparatus 3b.

The front differential apparatus 3a is coupled to the left front wheel 2a and the right front wheel 2b via a drive shaft. A part of the driving force output from the drive source 11 is transmitted to the front differential apparatus 3a and then distributed and transmitted by the front differential apparatus 3a to the left front wheel 2a and the right front wheel 2b.

The rear differential apparatus 3b is coupled to the left rear wheel 2c and the right rear wheel 2d via a drive shaft. A part of the driving force output from the drive source 11 is transmitted to the rear differential apparatus 3b and then distributed and transmitted by the rear differential apparatus 3b to the left rear wheel 2c and the right rear wheel 2d.

In the example of FIG. 4, all the wheels 2 of the vehicle 1 are located on the low μ road 51. Under this conditions, even when the driving force of the vehicle 1 is small, slip is likely to occur at each of the wheels 2. Thus, for example, slip may occur at all the wheels 2. In that case, for example, the normal traction control is used to stabilize the behavior of the vehicle 1 by eliminating the slip of each of the wheels 2.

In the normal traction control, for example, the control unit 15b controls the drive source 11 so as to reduce the driving force of the vehicle 1 (i.e., the driving force output from the drive source 11). For example, when it is determined that slip is occurring at at least one of the wheels 2, the control unit 15b execute the normal traction control to reduce the driving force of the vehicle 1. Accordingly, the slip of the wheel 2 is eliminated. It should be noted that, for example, when a slip rate of the wheel 2 exceeds a target slip rate, the control unit 15b may determine that slip is occurring at the wheel 2. Here, the slip rate is an index of how much the wheel 2 is slipping on a road surface and, for example, a value obtained by dividing a difference between a speed of the vehicle 1 (i.e., vehicle speed) and a wheel speed by the speed of the vehicle 1. The acquisition unit 15a can acquire the speed of the vehicle 1, for example, based on the detection result of each of the wheel speed sensors 13.

The control unit 15b may generate a braking force to the wheel 2 at which slip is occurring, in addition to reducing the driving force of the vehicle 1, in the normal traction control. For example, the control unit 15b can generate a braking force to the wheel 2 at which the slip is occurring, by opening the inlet valve 41 corresponding to the wheel 2, closing the outlet valve 42 corresponding to the wheel 2, closing the first valve 43, opening the second valve 44, and driving the pump 46.

### Operation of Control Apparatus

The operation of the control apparatus 15 according to the embodiment of the invention will be described with reference to FIG. 5 to FIG. 11.

As described above, the control unit 15b of the control apparatus 15 can execute the traction control as a control for stabilizing the behavior of the vehicle 1 by eliminating slip of the wheels 2 due to a driving force. Various situations in which slip of the wheels 2 occurs due to a driving force are conceivable. Thus, it is desirable to respond to an ongoing situation to optimize the behavior of the vehicle 1.

FIG. 5 is a diagram illustrating a state in which the vehicle 1 travels on an off-road. The off-road refers to an unpaved road. As illustrated in FIG. 5, bumps 52 protruding upwards from the road surface are present on the off-road. In the example of FIG. 5, the right front wheel 2b and the left rear wheel 2c are located on the bumps 52. Thus, the left front wheel 2a and the right rear wheel 2d are floating off the road surface. The vehicle 1 may be stuck in the state illustrated in FIG. 5, becoming incapable of moving forward. In that case, slip occurs at the wheels 2 floating off the road surface (the left front wheel 2a and the right rear wheel 2d in the example of FIG. 5).

If the normal traction control is executed in a situation in which the vehicle 1 is stuck on the off-road as illustrated in FIG. 5, the driving force of the vehicle 1 may be reduced due to the normal traction control. This makes it difficult for the vehicle 1 to escape from the bumps 52, and the stuck state of the vehicle 1 is unlikely to be eliminated. Then, the control unit 15b can execute the off-road traction control which is a traction control for off-road travel to eliminate the stuck state of the vehicle 1 in the above-described situation and is different from the normal traction control.

In the off-road traction control, for example, the control unit 15b generates a braking force to the wheel 2 at which slip is occurring, and increases the driving force of the vehicle 1. For example, when it is determined that slip is occurring at at least one of the wheels 2, the control unit 15b executes the normal traction control or the off-road traction control by switching therebetween in response to the behavior of the vehicle 1. Accordingly, the off-road traction control can be executed in a situation in which the vehicle 1 is stuck on the off-road as illustrated in FIG. 5. The details of a process of switching the traction control in response to the behavior of the vehicle 1 will be described below.

FIG. 6 is a diagram illustrating an example of the transitions of a driving force DF and a braking force BF of the vehicle 1 in each traction control performed by the control apparatus 15. FIG. 6 illustrates the transitions of the driving force DF and the braking force BF, where the horizontal axis represents a time T and the vertical axis represents the driving force DF and the braking force BF of the vehicle 1.

In FIG. 6, solid lines indicate the transitions of the driving force DF and the braking force BF when the off-road traction control is executed at a time point T1. In addition, in FIG. 6, dash-double-dot lines indicate the transitions of the driving force DF and the braking force BF if the normal traction control is executed at the time point T1. As indicated by the dash-double-dot lines in FIG. 6, when the normal traction control is started at the time point T1, for example, the driving force DF is decreased. On the other hand, as indicated by the solid lines in FIG. 6, when the off-road traction control is started at the time point T1, for example, the driving force DF is increased and the braking force BF (specifically, the braking force acting on the wheel 2 at which slip is occurring) is generated.

As described above, the control unit 15b may generate a braking force at the wheel 2 at which slip is occurring in the normal traction control. In this respect, in the off-road traction control, the control unit 15b generates a larger braking force than in the normal traction control to the wheel 2 at which slip is occurring.

For example, in the example illustrated in FIG. 5, when the off-road traction control is executed, a braking force is automatically generated at the left front wheel 2a and the right rear wheel 2d at which slip is occurring. Accordingly, of the driving force distributed from the front differential apparatus 3a to the left front wheel 2a and the right front wheel 2b, the ratio of the driving force distributed to the right front wheel 2b located on the bump 52 is increased. In addition, of the driving force distributed from the rear differential apparatus 3b to the left rear wheel 2c and the right rear wheel 2d, the ratio of the driving force distributed to the left rear wheel 2c located on the bump 52 is increased. As a result, the thrust force of the vehicle 1 is increased.

In addition, in the example of FIG. 5, when the off-road traction control is executed, the driving force of the vehicle 1 (specifically, the driving force output from the drive source 11) is automatically increased. As a result, the thrust force of the vehicle 1 is further increased. Therefore, escape of the vehicle 1 from the bumps 52 and elimination of the stuck state of the vehicle 1 can be appropriately achieved. It should be noted that, in the off-road traction control, the control unit 15b may perform only a process of generating a braking force at the wheel 2 at which slip is occurring without performing a process of increasing the driving force of the vehicle 1. Also in that case, the thrust force of the vehicle 1 can be increased by the off-road traction control, and thus escape of the vehicle 1 from the bumps 52 and elimination of the stuck state of the vehicle 1 can be achieved.

As described above, the control unit 15b of the control apparatus 15 automatically executes the off-road traction control in response to the behavior of the vehicle 1. Thus, it is possible to respond to an ongoing situation and optimize the behavior of the vehicle 1. Specifically, the control unit 15b automatically changes the processing mode of the traction control in response to the behavior of the vehicle 1. Accordingly, automatic execution of the off-road traction control in response to the behavior of the vehicle 1 can be achieved. The processing mode of the traction control refers to the mode of processing performed by the control unit 15b in relation to the traction control.

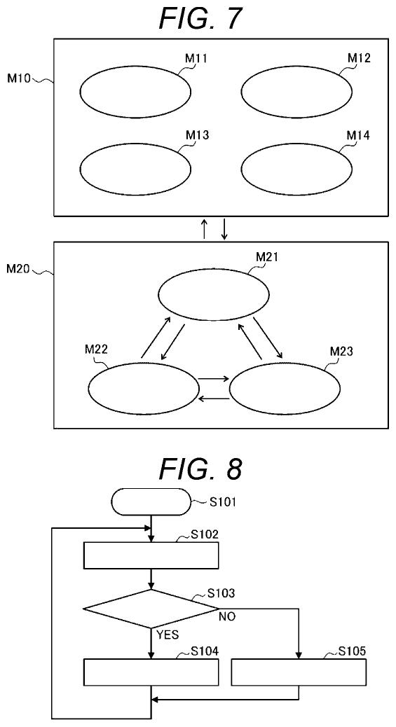

FIG. 7 is a diagram for explaining the transition of the processing mode of the traction control performed by the control apparatus 15. As illustrated in FIG. 7, the processing mode of the traction control is switched between a prohibition mode M10 and a permission mode M20. The prohibition mode M10 is a mode in which the off-road traction control is prohibited. The permission mode M20 is a mode in which the off-road traction control can be permitted.

When any of off-road traction control prohibition conditions to be described below is satisfied, the control unit 15b causes the processing mode of the traction control to transition to the prohibition mode M10. On the other hand, when none of the off-road traction control prohibition conditions is satisfied, the control unit 15b causes the processing mode of the traction control to transition to the permission mode M20.

The prohibition mode M10 includes a first prohibition mode M11, a second prohibition mode M12, a third prohibition mode M13, and a fourth prohibition mode M14.

The first prohibition mode M11 is a mode the transition to which is caused when a first prohibition condition is satisfied. The first prohibition condition is that the vehicle 1 is stopped. That is, when it is determined that the vehicle 1 is stopped, the control unit 15b causes the processing mode of the traction control to transition to the first prohibition mode M11 to prohibit the off-road traction control. For example, when the speed of the vehicle 1 is below a lower limit speed, the control unit 15b determines that the vehicle 1 is stopped. The lower limit speed is, for example, a predetermined speed higher than 0 km/h but close to 0 km/h. The control unit 15b may determine that the vehicle 1 is stopped when a state in which the speed of the vehicle 1 is below the lower limit speed continues for a predetermined period of time.

When the vehicle 1 is stopped, even if the vehicle 1 is stuck on an off-road, it can be assumed that there is little need to make the vehicle 1 escape from the bump 52 and eliminate the stuck state of the vehicle 1. Thus, in such a case, the off-road traction control is prohibited so as to prevent unwanted execution of the off-road traction control.

The second prohibition mode M12 is a mode the transition to which is caused when a second prohibition condition is satisfied. The second prohibition condition is that the speed of the vehicle 1 is higher than a reference speed. That is, when it is determined that the speed of the vehicle 1 is higher than the reference speed, the control unit 15b causes the processing mode of the traction control to transition to the second prohibition mode M12 to prohibit the off-road traction control. The reference speed is, for example, a speed which is high enough to determine that a situation in which the vehicle 1 is stuck on an off-road is not caused. The control unit 15b may prohibit the off-road traction control when a state in which the speed of the vehicle 1 is higher than the reference speed continues for a predetermined period of time.

When the speed of the vehicle 1 is higher than the reference speed, it can be assumed that a situation in which the vehicle 1 is stuck on an off-road is not caused. Thus, in such a case, the off-road traction control is prohibited so as to prevent unwanted execution of the off-road traction control.

The third prohibition mode M13 is a mode the transition to which is caused when a third prohibition condition is satisfied. The third prohibition condition is that slip is occurring at all the wheels 2. That is, when it is determined that slip is occurring at all the wheels 2, the control unit 15b causes the processing mode of the traction control to transition to the third prohibition mode M13 to prohibit the off-road traction control. As described above, for example, when a slip rate of the wheel 2 exceeds a target slip rate, the control unit 15b may determine that slip is occurring at the wheel 2.

When slip is occurring at all the wheels 2, it can be assumed that a situation in which the vehicle 1 is stuck on an off-road is not caused and, for example, all the wheels 2 are located on the low μ road 51 as illustrated in the example of FIG. 4. Thus, in such a case, the off-road traction control is prohibited and the normal traction control is executed, so that the behavior of the vehicle 1 can be stabilized.

The fourth prohibition mode M14 is a mode the transition to which is caused when a fourth prohibition condition is satisfied. The fourth prohibition condition is that the driver of the vehicle 1 does not have an acceleration intention. That is, when it is determined that the driver of the vehicle 1 does not have an acceleration intention, the control unit 15b causes the processing mode of the traction control to transition to the fourth prohibition mode M14 to prohibit the off-road traction control. The acceleration intention refers to an intention to accelerate the vehicle 1. For example, in a situation in which the vehicle 1 is stuck on an off-road, the acceleration intention refers to an intention to make the vehicle 1 escape from the bump 52 and eliminate the stuck state of the vehicle 1.

The control unit 15b determines whether the driver of the vehicle 1 has the acceleration intention, for example, based on the driving force of the vehicle 1 (i.e., the driving force output from the drive source 11). For example, the control unit 15b determines that the driver of the vehicle 1 has the acceleration intention when the driving force of the vehicle 1 is greater than a threshold value, or determines that the driver of the vehicle 1 does not have the acceleration intention when the driving force of the vehicle 1 is smaller than the threshold value.

The control unit 15b may determines whether the driver of the vehicle 1 has the acceleration intention in consideration of the braking force of the vehicle 1 (i.e., a braking force applied to the vehicle 1 by the hydraulic pressure control unit 12) in addition to the driving force of the vehicle 1. For example, the control unit 15b determines that the driver of the vehicle 1 has the acceleration intention when a value obtained by subtracting the braking force of the vehicle 1 from the driving force of the vehicle 1 is greater than a threshold value, or determines that the driver of the vehicle 1 does not have the acceleration intention when the value is smaller than the threshold value.

The control unit 15b may determine whether the driver of the vehicle 1 has the acceleration intention in consideration of the gradient of the travel road of the vehicle 1 in addition to the driving force of the vehicle 1. For example, in a situation in which the vehicle 1 travels on an ascending slope, the control unit 15b determines that the driver of the vehicle 1 has the acceleration intention when a value obtained by subtracting a component of gravity in a vehicle front-rear direction acting on the vehicle 1 due to the gradient of the travel road from the driving force of the vehicle 1 is greater than a threshold value, or determines that the driver of the vehicle 1 does not have the acceleration intention when the value is smaller than the threshold value. The acquisition unit 15a can acquire the gradient of the travel road, for example, based on the detection result of the inertia measurement unit 14. The larger the gradient of the travel road is, the larger value the control unit 15b can determine as a component of gravity in the vehicle front-rear direction acting on the vehicle 1 due to the gradient of the travel road.

In a case where the driver of the vehicle 1 does not have the acceleration intention, even if the vehicle 1 is stuck on an off-road, it can be assumed that there is little need to make the vehicle 1 escape from the bump 52 and eliminate the stuck state of the vehicle 1. Thus, in such a case, the off-road traction control is prohibited so as to prevent unwanted execution of the off-road traction control.

In the permission mode M20, the control unit 15b estimates a stuck probability which is a probability of occurrence of a situation in which the vehicle 1 is stuck on an off-road, and determines the traction control to be executed based on the estimation result of the stuck probability. Specifically, as will be described below, the control unit 15b sets the traction control to be executed to the off-road traction control when the stuck probability is higher than a reference value, or sets the traction control to be executed to the normal traction control when the stuck probability is lower than the reference value.

It should be noted that information indicating which of the off-road traction control and the normal traction control is set as the traction control to be executed is stored, for example, in a storage element of the control apparatus 15. When it is determined that a condition for executing the traction control is satisfied (e.g., when it is determined that slip is occurring at at least one of the wheels 2), the control unit 15b executes the traction control which is set as the traction control to be executed. For example, a set mode in which the normal traction control is set as the traction control to be executed may be called a normal mode, and a set mode in which the off-road traction control is set as the traction control to be executed may be called an off-road mode.

The permission mode M20 includes a low probability mode M21, a medium probability mode M22, and a high probability mode M23.

The low probability mode M21 is a mode the transition to which is caused when it is estimated that the stuck probability is low. The high probability mode M23 is a mode the transition to which is caused when it is estimated that the stuck probability is high. The medium probability mode M22 is a mode the transition to which is caused when it is estimated that the stuck probability is higher than in the low probability mode M21 and is lower than in the high probability mode M23. In the permission mode M20, the processing mode is switched between the low probability mode M21, the medium probability mode M22, and the high probability mode M23 based on the stuck probability estimation result. It should be noted that when the processing mode transitions from one of the low probability mode M21 and the high probability mode M23 to the other, the transition may be caused with the intervention of the medium probability mode M22, or the transition may be directly caused without the intervention of the medium probability mode M22.

FIG. 8 is a flowchart illustrating an example of a processing flow in the permission mode M20 performed by the control apparatus 15. Step S101 in FIG. 8 corresponds to the start of the processing flow illustrated in FIG. 8. The processing flow illustrated in FIG. 8 starts when the processing mode of the traction control transitions to the permission mode M20. The processing flow illustrated in FIG. 8 ends when the processing mode of the traction control transitions to the prohibition mode M10.

After the processing flow illustrated in FIG. 8 is started, in step S102, the control unit 15b estimates a stuck probability. As described above, the stuck probability is a probability of occurrence of a state in which the vehicle 1 is stuck on an off-road.

In step S102, the control unit 15b may estimate a stuck probability, for example, based on the acceleration of the wheel 2 (specifically, the acceleration of the wheel 2 at which slip is not occurring). When slip is occurring at some of the wheels 2, it is necessary to determine whether the slip is caused due to the vehicle 1 being stuck on an off-road, or due to another factor.

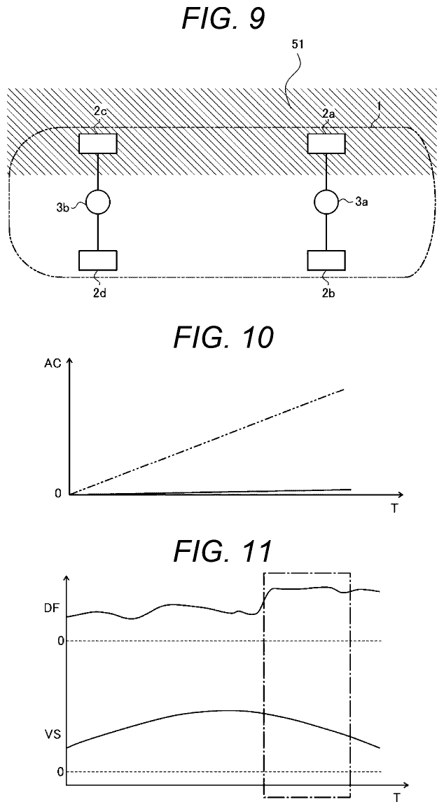

FIG. 9 is a diagram illustrating a state in which only the wheels 2 of the vehicle 1 on the left side (i.e., the left front wheel 2a and the left rear wheel 2c) are located on the low μ road 51. In the example of FIG. 9, while the left front wheel 2a and the left rear wheel 2c are located on the low μ road 51, the right front wheel 2b and the right rear wheel 2d are not located on the low μ road 51. In this situation, slip may occur only at the left front wheel 2a and the left rear wheel 2c.

If the off-road traction control is executed in a situation in which, among the wheels 2 of the vehicle 1, only the wheels 2 on one of the left side and the right side (the left front wheel 2a and the left rear wheel 2c in the example of FIG. 9) are located on the low μ road 51 as in the example of FIG. 9, the vehicle 1 moves mainly by the grip forces of the wheels 2 on the other of the left side and the right side (the right front wheel 2b and the right rear wheel 2d in the example of FIG. 9). Thus, the vehicle 1 may turn to the low μ road 51 side (the left side in the example of FIG. 9) and all the wheels 2 may enter the low μ road 51, making the behavior of the vehicle 1 more unstable.

Therefore, in a situation in which, among the wheels 2 of the vehicle 1, only the wheels 2 on one of the left side and the right side are located on the low μ road 51 as in the example of FIG. 9, the behavior of the vehicle 1 is to be stabilized by the normal traction control rather than the off-road traction control. Then, based on the acceleration of the wheels 2 at which slip is not occurring, the control unit 15b determines which situation occurs, a situation in which, among the wheels 2 of the vehicle 1, only the wheels 2 on one of the left side and the right side are located on the low μ road 51 as in the example of FIG. 9, or a situation in which the vehicle 1 is stuck on an off-road.

FIG. 10 is a diagram illustrating an example of the transition of an acceleration AC of the wheel 2 of the vehicle 1 (specifically, the acceleration of the wheel 2 at which slip is not occurring). FIG. 10 illustrates the acceleration AC of the wheel 2, where the horizontal axis represents a time T and the vertical axis represents the acceleration AC of the wheel 2 at which slip is not occurring. The acquisition unit 15a can acquire the acceleration AC of the wheel 2 (i.e., the acceleration of the wheel 2 in the vehicle front-rear direction), for example, based on the detection result of the wheel speed sensors 13.

In a situation in which the vehicle 1 is stuck on an off-road, the acceleration AC of the wheel 2 does not significantly increase over time, as indicated by the solid line in FIG. 10. On the other hand, in a situation in which, among the wheels 2 of the vehicle 1, only the wheels 2 on one of the left side and the right side are located on the low μ road 51 as in the example of FIG. 9, the acceleration AC of the wheel 2 significantly increases over time as indicated by the dash-double-dot line in FIG. 10, as compared to the situation in which the vehicle 1 is stuck on an off-road. Then, the control unit 15b estimates a stuck probability based on, for example, the increase in the acceleration AC of the wheel 2 during the elapse of a predetermined time period.

For example, when the increase in the acceleration AC of the wheel 2 during the elapse of the predetermined time period is less than a first threshold value, the control unit 15b estimates that the stuck probability is high. In this case, for example, the processing mode transitions to the high probability mode M23 of FIG. 7. For example, when the increase in the acceleration AC of the wheel 2 during the elapse of the predetermined time period is greater than the first threshold value and less than a second threshold value which is greater than the first threshold value, the control unit 15b estimates that the stuck probability is medium. In this case, for example, the processing mode transitions to the medium probability mode M22 of FIG. 7. For example, when the increase in the acceleration AC of the wheel 2 during the elapse of the predetermined time period is greater than the second threshold value, the control unit 15b estimates that the stuck probability is low. In this case, for example, the processing mode transitions to the low probability mode M21 of FIG. 7. The control unit 15b may sequentially change the stuck probability in accordance with the increase in the acceleration AC of the wheel 2 during the elapse of the predetermined time period.

In step S102, the control unit 15b may estimate the stuck probability, for example, based on the driving force and the speed of the vehicle 1.

FIG. 11 is a diagram illustrating an example of the transitions of a driving force DF and a speed VS of the vehicle 1. FIG. 11 illustrates the transitions of the driving force DF and the speed VS, where the horizontal axis represents a time T and the vertical axis represents the driving force DF and the speed VS of the vehicle 1.

In the example of FIG. 11, the vehicle 1 travels in a state in which the driving force DF is continuously output from the drive source 11. The speed VS of the vehicle 1 increases, and then decreases in the region indicated by the dash-dotted line in FIG. 11. When the driving force DF is maintained at a relatively high value and the speed VS decreases (i.e., the vehicle 1 decelerates) as in the region indicated by the dash-dotted line in FIG. 11, the vehicle 1 can be assumed to be stuck on an off-road.

Thus, for example, when the driving force DF is maintained at a relatively high value and the speed VS decreases, the control unit 15b may estimate that the stuck probability is increased. For example, when the driving force DF is maintained at a relatively high value and the speed VS decreases in a state in which the processing mode is the low probability mode M21 of FIG. 7, the control unit 15b may cause the processing mode to transition to the medium probability mode M22 of FIG. 7. For example, when the driving force DF is maintained at a relatively high value and the speed VS decreases in a state in which the processing mode is the medium probability mode M22 of FIG. 7, the control unit 15b may cause the processing mode to transition to the high probability mode M23 of FIG. 7.

In the above, an example in which the stuck probability is estimated based on the acceleration of the wheel 2 at which slip is not occurring, and an example in which the stuck probability is estimated based on the driving force and the speed of the vehicle 1 have been described. However, the control unit 15b may estimate the stuck probability based on both the acceleration of the wheel 2 at which slip is not occurring and the driving force and the speed of the vehicle 1, or may estimate the stuck probability based on only one of the acceleration of the wheel 2 at which slip is not occurring and the driving force and the speed of the vehicle 1.

Following step S102 in FIG. 8, in step S103, the control unit 15b determines whether the stuck probability is higher than a reference value.

In step S103, for example, the control unit 15b determines that the stuck probability is lower than the reference value when the processing mode is the low probability mode M21 of FIG. 7, or determines that the stuck probability is higher than the reference value when the processing mode is the high probability mode M23 of FIG. 7. Here, for example, when the processing mode is the medium probability mode M22 of FIG. 7, the control unit 15b determines that the stuck probability is higher than the reference value when a predetermined condition is satisfied, or determines that the stuck probability is lower than the reference value when the predetermined condition is not satisfied.

Examples of the predetermined condition described above include a time period, during which the processing mode is maintained in the medium probability mode M22 of FIG. 7, being in excess of a threshold value. That is, the control unit 15b may estimate that the longer the processing mode is maintained in the medium probability mode M22 of FIG. 7, the higher the stuck probability is.

Examples of the predetermined condition described above include a time, which has elapsed since a time point of the transition of the processing mode from the high probability mode M23 to the medium probability mode M22 of FIG. 7, being shorter than a threshold value. That is, the control unit 15b may estimate that the shorter the elapsed time since a time point of the transition of the processing mode from the high probability mode M23 to the medium probability mode M22 of FIG. 7 is, the higher the stuck probability is.

When the processing mode is the medium probability mode M22 of FIG. 7, the control unit 15b may change the stuck probability in consideration of a parameter other than a time period during which the processing mode is maintained in the medium probability mode M22 of FIG. 7 and a time which has elapsed since a time point of the transition of the processing mode from the high probability mode M23 to the medium probability mode M22 of FIG. 7. For example, when the processing mode is the medium probability mode M22 of FIG. 7, the control unit 15b may determine that the driver of the vehicle 1 does not have the acceleration intention when the driving force of the vehicle 1 is low, and may decrease the stuck probability.

When it is determined that the stuck probability is higher than the reference value (step S103/YES), the processing proceeds to step S104. In step S104, the control unit 15b sets the traction control to be executed to the off-road traction control (i.e., sets a set mode of the traction control to the off-road mode) and returns to step S102. In this case, for example, when it is determined that slip is occurring at at least one of the wheels 2, the off-road traction control is executed.

On the other hand, when it is determined that the stuck probability is lower than the reference value (step S103/NO), the processing proceeds to step S105. In step S105, the control unit 15b sets the traction control to be executed to the normal traction control (i.e., sets a set mode of the traction control to the normal mode) and returns to step S102. In this case, for example, when it is determined that slip is occurring at at least one of the wheels 2, the normal traction control is executed.

Examples of the processing performed by the control apparatus 15 have been described above. However, the processing performed by the control apparatus 15 is not limited to the above-described examples, and may be, for example, processing obtained by appropriately modifying the above-described examples.

For example, an example in which the control unit 15b estimates a stuck probability in three levels (specifically, in the permission mode M20, the processing mode switches between the low probability mode M21, the medium probability mode M22, and the high probability mode M23 in accordance with the stuck probability) has been described above. However, the control unit 15b may estimate a stuck probability in more levels. In addition, the control unit 15b may estimate a stuck probability in two levels, that is, a low probability and a high probability.

For example, an example in which the control unit 15b uses, as the prohibition condition for the off-road traction control, the first prohibition condition, the second prohibition condition, the third prohibition condition, and the fourth prohibition condition (specifically, an example in which the prohibition mode M10 includes the first prohibition mode M11, the second prohibition mode M12, the third prohibition mode M13, and the fourth prohibition mode M14) has been described above. However, the control unit 15b does not necessarily use some or all of the first prohibition condition, the second prohibition condition, the third prohibition condition, and the fourth prohibition condition as the prohibition condition for the off-road traction control. That is, some or all of the first prohibition mode M11, the second prohibition mode M12, the third prohibition mode M13, and the fourth prohibition mode M14 may be omitted from the prohibition mode M10.

Effects of the control apparatus 15 according to the embodiment of the invention will be described.

The control apparatus 15 includes the control unit 15b that execute, when slip of the wheel 2 occurs due to a driving force, the first control of eliminating the slip (the normal traction control in the above example) and the second control of generating a larger braking force, as compared to the first control, at the wheel 2 at which the slip is occurring (the off-road traction control in the above example). The control unit 15b automatically executes the second control in response to the behavior of the vehicle 1. Accordingly, the first control and the second control can be automatically switched and executed in accordance with an ongoing situation with a focus on the behavior of the vehicle 1. Thus, the behavior of the vehicle 1 can be optimized.

Further, according to the control apparatus 15, since the first control and the second control can be automatically switched and executed, there is no need to manually switch between a set mode in which the first control is set as the traction control to be executed and a set mode in which the second control is set as the traction control to be executed. Therefore, it is possible to prevent the addition of an apparatus used for switching between the set modes, and to reduce the time and effort required for switching between the set modes.

In the control apparatus 15, during the second control (the off-road traction control in the above example), the control unit 15b preferably generates a larger braking force than in the first control (the normal traction control in the above example) at the wheel 2 at which slip is occurring, and increases the driving force of the vehicle 1. As a result, the thrust force of the vehicle 1 is more effectively increased by the second control. Therefore, escape of the vehicle 1 from the bump 52 and elimination of the stuck state of the vehicle 1 can be more appropriately achieved by the second control.

In the control apparatus 15, when it is determined that the vehicle 1 is stopped, the control unit 15b preferably prohibits the second control (the off-road traction control in the above example). Accordingly, unwanted execution of the second control can be prevented when the vehicle 1 is stopped.

In the control apparatus 15, when it is determined that the speed of the vehicle 1 is higher than the reference speed, the control unit 15b preferably prohibits the second control (the off-road traction control in the above example). Accordingly, unwanted execution of the second control can be prevented when the speed of the vehicle 1 is higher than the reference speed.

In the control apparatus 15, when it is determined that slip is occurring at all the wheels 2, the control unit 15b preferably prohibits the second control (the off-road traction control in the above example). Accordingly, by prohibiting the second control when slip is occurring at all the wheels 2, the first control (the normal traction control in the above example) can be executed to stabilize the behavior of the vehicle 1.

In the control apparatus 15, when it is determined that the driver of the vehicle 1 does not have the acceleration intention, the control unit 15b preferably prohibits the second control (the off-road traction control in the above example). Accordingly, unwanted execution of the second control can be prevented when the driver of the vehicle 1 does not have the acceleration intention.

In the control apparatus 15, the control unit 15b preferably executes the second control (the off-road traction control in the above example) based on the acceleration of the wheel 2 at which slip is not occurring. Accordingly, the second control can be executed after a stuck probability is appropriately estimated in consideration of the acceleration of the wheel 2 at which slip is not occurring. Thus, it is possible to respond to an ongoing situation and appropriately execute the second control after determining whether slip is caused due to the vehicle 1 being stuck on an off-road, or due to another factor.

In the control apparatus 15, the control unit 15b preferably executes the second control (the off-road traction control in the above example) based on the driving force and the speed of the vehicle 1. Accordingly, the second control can be executed after a stuck probability is appropriately estimated in consideration of the driving force and the speed of the vehicle 1. Thus, it is possible to respond to an ongoing situation and appropriately execute the second control after determining whether slip is caused due to the vehicle 1 being stuck on an off-road, or due to another factor.

Although the preferred embodiment of the invention has been described above with reference to the accompanying drawings, it is obvious that the invention is not limited to the above-described embodiment, and it is also obvious that various changes and modifications within the scope described in the claims also belong to the technical scope of the invention.

For example, the processing described in the present specification using a flowchart may not necessarily be performed in the order shown in the flowchart. Some processing steps may be performed in parallel. In addition, additional processing steps may be employed, or some processing steps may be omitted.

In addition, for example, the series of processing performed by the control apparatus 15 described above may be implemented using any of software, hardware, and a combination of software and hardware. For example, a program constituting the software is stored in advance in a storage medium provided inside or outside an information processing apparatus.

What is claimed is:

1. A control apparatus (15) for controlling a behavior of a vehicle (1), the control apparatus comprising a control unit (15b) configured to execute, when slip of wheels (2) occurs due to a drive force, a first control of eliminating the slip and a second control of generating a larger braking force, as compared to the first control, at any of the wheels (2) at which the slip is occurring, wherein the control unit (15b) automatically executes the second control in response to the behavior of the vehicle (1).

2. The control apparatus according to claim 1, wherein in the second control, the control unit (15b) generates a larger braking force, as compared to the first control, at any of the wheels (2) at which the slip is occurring, and increases the drive force of the vehicle (1).

3. The control apparatus according to claim 2, wherein the control unit (15b) prohibits the second control when it is determined that the vehicle (1) is stopped.

4. The control apparatus according to claim 1, wherein the control unit (15b) prohibits the second control when it is determined that a speed of the vehicle (1) is higher than a reference speed.

5. The control apparatus according to claim 1, wherein the control unit (15b) prohibits the second control when it is determined that the slip is occurring at all the wheels (2).

6. The control apparatus according to claim 1, wherein the control unit (15b) prohibits the second control when it is determined that a driver of the vehicle (1) does not have an acceleration intention.

7. The control apparatus according to claim 1, wherein the control unit (15b) executes the second control based on an acceleration of any of the wheels (2) at which the slip is not occurring.

8. The control apparatus according to claim 1, wherein the control unit (15b) executes the second control based on a drive force and a speed of the vehicle (1).

9. A control method for controlling a behavior of a vehicle (1), the control method causing a control unit (15b) of a control apparatus (15) to execute, when slip of wheels (2) occurs due to a drive force, a first control of eliminating the slip and a second control of generating a larger braking force, as compared to the first control, to any of the wheels (2) at which the slip is occurring, wherein the control unit (15b) automatically executes the second control in response to a behavior of the vehicle (1).

10. The control apparatus according to claim 2, wherein the control unit (15b) prohibits the second control when it is determined that a speed of the vehicle (1) is higher than a reference speed.

11. The control apparatus according to claim 2, wherein the control unit (15b) prohibits the second control when it is determined that the slip is occurring at all the wheels (2).

12. The control apparatus according to claim 2, wherein the control unit (15b) prohibits the second control when it is determined that a driver of the vehicle (1) does not have an acceleration intention.

13. The control apparatus according to claim 2, wherein the control unit (15b) executes the second control based on an acceleration of any of the wheels (2) at which the slip is not occurring.

14. The control apparatus according to claim 2, wherein the control unit (15b) executes the second control based on a drive force and a speed of the vehicle (1).
